(19) United States
(12) Patent Application Publication
(10) Pub. No.: US 2017/0089210 A1
(43) Pub. Date: Mar. 30, 2017

(54) SEAL ARRANGEMENT FOR COMPRESSOR OR TURBINE SECTION OF GAS TURBINE ENGINE

(71) Applicant: PRATT & WHITNEY CANADA CORP., Longueuil (CA)

(72) Inventor: Karan ANAND, Mississauga (CA)

(21) Appl. No.: 14/869,302

(22) Filed: Sep. 29, 2015

(51) Int. Cl. F01D 11/00; F01D 5/12; F04D 29/08; F04D 29/32; F04D 29/54; F01D 5/02; F01D 9/02

(52) U.S. Cl. CPC F01D 11/001; F01D 5/02; F01D 5/12; F01D 9/02; F04D 29/324; F04D 29/542; F04D 29/083; F05D 2220/32; F05D 2240/11

(57) ABSTRACT

A seal arrangement for a gas turbine engine comprises a rotor hub. A a stator portion projects toward the rotor hub, an annular gap formed between the rotor hub and an end of the stator portion. A leakage path is defined from a first cavity on a first side of the stator portion, through the annular gap, and to a second cavity on a second side of the stator portion by positive pressure differential from the first cavity to the second cavity when in operation. A dynamic seal is secured to the rotor hub, the dynamic seal having geometrical features positioned relative to the annular gap to induce a flow of gas through the annular gap from the second cavity to the first cavity when in operation and rotating with the rotor hub.

### TECHNICAL FIELD

The application relates generally to sealing arrangements in compressor or turbine sections of gas turbine engines.

### BACKGROUND OF THE ART

Under-stator leakage is an occurrence in gas turbine engines. Under-stator leakage occurs at a junction between rotating components (e.g., rotors) and stationary components, such as shrouded stators. In compressor sections of gas turbine engines, gas leaks from a downstream cavity to an upstream cavity due to higher downstream static pressure in the main gaspath.

Under-stator leakage may be controlled by using seals, such as labyrinth seals or brush seals, to form a tortuous path between the rotating component and the stationary component. However, such seals may not completely block leakage. As a result, leakage flow may disrupt the core flow in the main gaspath, and this may affect compressor efficiency and reduce compressor stall margins.

### SUMMARY

In one aspect, there is provided a seal arrangement for a gas turbine engine comprising: a rotor hub; a stator portion projecting toward the rotor hub, an annular gap formed between the rotor hub and an end of the stator portion, a leakage path being defined from a first cavity on a first side of the stator portion, through the annular gap, and to a second cavity on a second side of the stator portion by positive pressure differential from the first cavity to the second cavity when in operation; and a dynamic seal secured to the rotor hub, the dynamic seal having geometrical features positioned relative to the annular gap to induce a flow of gas through the annular gap from the second cavity to the first cavity when in operation and rotating with the rotor hub.

According to a second aspect, there is provided a gas turbine engine of the type having at least one of a turbine section and a compressor section defined by a rotor hub, a stator portion projecting toward the rotor hub, an annular gap formed between the rotor hub and an end of the stator portion, a leakage path being defined from a first cavity on a first side of the stator portion, through the annular gap, and to a second cavity on a second side of the stator portion by positive pressure differential from the first cavity to the second cavity when in operation, the gas turbine engine comprising: a dynamic seal secured to the rotor hub, the dynamic seal having geometrical features positioned relative to the annular gap opposite the end of the stator portion.

In a third aspect, there is provided a method for sealing a leakage path in a gas turbine engine, the leakage path being defined from a first cavity on a first side of a stator portion, through an annular gap, and to a second cavity on a second side of the stator portion, the method comprising: receiving gas in the first cavity during operation of the gas turbine engine, such that a pressure in the first cavity is greater than a pressure in the second cavity; and inducing a flow of gas with a dynamic seal from the second cavity, through the annular gap, to the first cavity, by rotation of the rotor hub.

Further details of these and other aspects of the present invention will be apparent from the detailed description and figures included below.

### DESCRIPTION OF THE DRAWINGS

Reference is now made to the accompanying figures, in which:

FIG. 1 is a schematic cross-sectional view of a compressor section of a turbofan gas turbine engine with a sealing system in accordance with the present disclosure;

FIG. 2 is an enlarged view of an exemplary dynamic seal of the sealing system of FIG. 1, with airfoil-shaped fins; and

FIG. 3 is an enlarged view of another exemplary dynamic seal of the sealing system of FIG. 1, with airfoil-shaped fins.

### DETAILED DESCRIPTION OF THE PREFERRED EMBODIMENTS

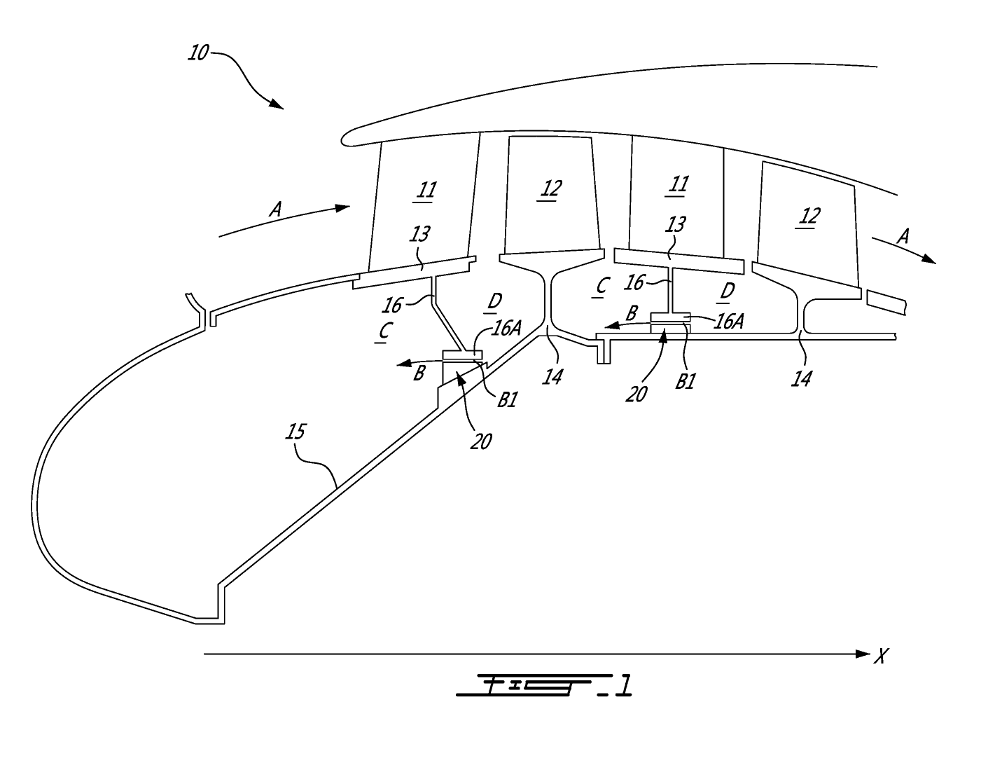

FIG. 1 illustrates a compressor section 10 of a turbofan gas turbine engine of a type preferably provided for use in subsonic flight. The compressor section 10 pressurizes the air, for the compressed air to be mixed with fuel and ignited in a combustor for generating an annular stream of hot combustion gases. A turbine section then extracts energy from the combustion gases.

The compressor section 10 defines an annular gaspath A in which stator vanes 11 and rotor blades 12 (a.k.a., airfoils) sequentially alternate. Although two compression stages are shown, fewer or more compression stages can be present. By rotation of the rotor blades 12, a static pressure increases in a downstream direction of the gaspath A, as indicated by directional arrow. An inner portion of the gaspath A is defined by inner shrouds 13 supporting the stator vanes 11, and rotor disks 14 supporting the rotor blades 12. The rotor disks 14 are rotatably mounted to a rotor hub 15 so as to rotate about axis X. Gas from the core flow in the main gaspath A may pass through a junction between the inner shrouds 13 and the rotor disks 14.

Stator platforms 16 or like stator portions project from the vanes 11 or inner shrouds 13 toward the rotor hub 15. Ends 16A of the platforms 16 are in close proximity to the rotor hub 15, annular gaps B1 being formed between the ends 16A of the stator platforms 16 and the rotor hub 15. The expression “under stator” may be used to define the location of the gaps B1, as they are located inwardly of the innermost parts of the stator platforms 16. The end 16A of the stator platforms 16 may have an annular surface that may be axisymmetric, etc. Cavities are defined on opposite sides of the stator platforms 16, and are illustrated as C and D. As the static pressure increases along the gaspath A due to the action of the rotor blades 12, gas enters the cavity D at the junction between the inner shrouds 13 and the rotor disks 14. Therefore, because of the positive pressure differential, a leakage path is formed from cavity D, through the annular gap B1, to the cavity C, as illustrated by B.

Referring to FIG. 1, a sealing system is shown and features the rotor hub 15, the stator platforms 16 and the annular gaps B1. The sealing system is devised to reverse the fluid flow thereby limiting or preventing fluid leakage along leakage path B, namely through the annular gaps B1 from cavity D to cavity C, i.e., from a higher pressure cavity to a lower pressure cavity.

The sealing system has a dynamic seal 20. The dynamic seal 20 is defined by geometrical features provided on the surface of the rotor hub 15, and thereby rotating with the rotor hub 15. The geometrical features are arranged—positioned, oriented, sized—to induce a flow of gas through the annular gap B1, in a direction contrary to that of the leakage path B, or create a pressure differential across the annular gap B1 opposing or reducing the flow of air via the leakage path. In doing so, gas is blocked from flowing from the higher pressure cavity to the lower pressure cavity, as gas flows in the opposite direction by this pumping action. In this manner, pressure loss in an upstream direction at the annular gaps B1 is limited. The sealing system compressor section 10 may have one of more of the dynamic seal 20 depending for example on the number of compressor stages, or on the necessity for sealing action.

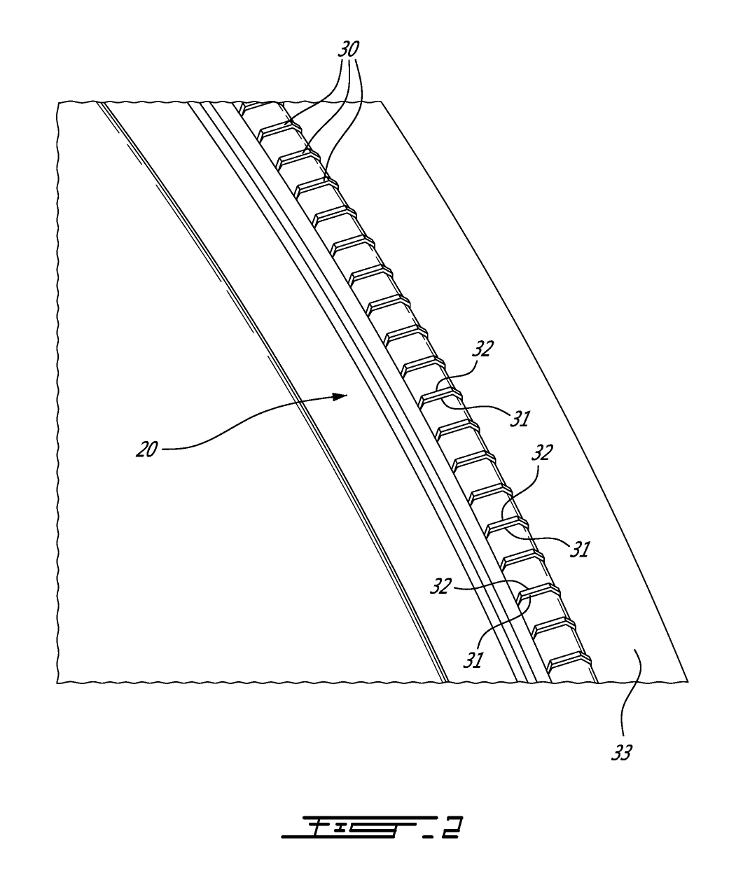

The geometrical features of the dynamic seals 20 may have different configurations, with FIGS. 1-3 providing non-exhaustively a few examples. Referring to FIG. 2, the geometrical features of the dynamic seal 20 are a plurality of blades 30 that may act as airfoils. Hence, as the blades 30 may be airfoils, reference is made hereinafter to airfoils 30. The airfoils 30 are circumferentially distributed on the surface of the rotor hub 15 with circumferential passages between. The airfoils 30 project from a surface of the rotor hub 15, toward the stator platform 16, yet with a radial passage therebetween to allow gas flow therethrough. The airfoils 30 may have a pressure surface 31 and a suction surface 32. The airfoils 30 may be mounted to a base ring 33 interfaced to the rotor hub 15, or may alternatively be directly part of the rotor hub 15. The use of a base ring 33 may facilitate manufacturing and installation on the rotor hub 15, for instance by having the dynamic seal being a single integral piece. Other configurations are considered, for example as a function of the shape of the stator ends at the annular gaps, the size of the gaps, etc.

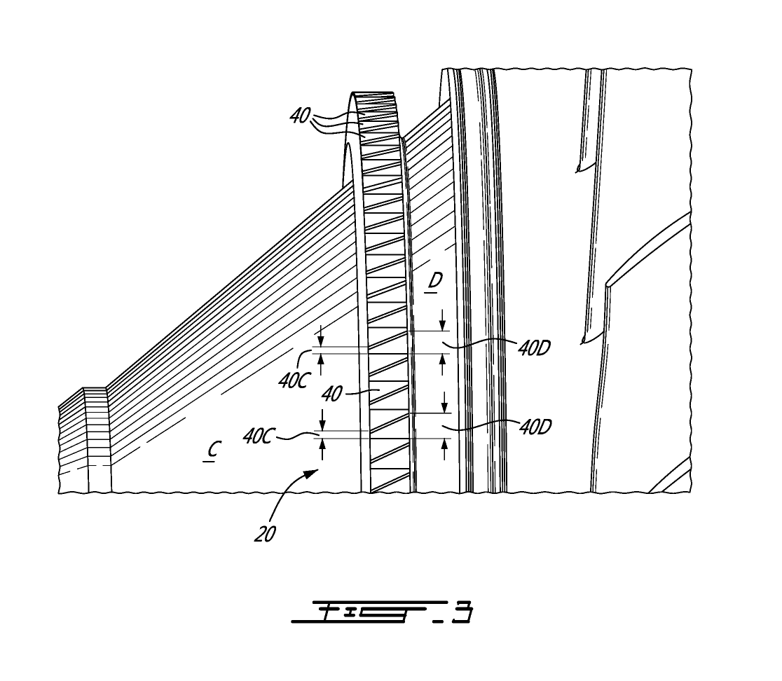

Referring to FIG. 3, the geometrical features of the dynamic seal 20 also features a plurality of airfoils, illustrated as 40. The geometry of the airfoils 40 differs from that of the airfoils 30 in that the airfoils 40 have straight surfaces, from leading edge to trailing edge. The thickness of each of the airfoils 40 varies from leading edge to trailing edge, such that the trailing edge passage width 40D is greater than the leading edge passage width 40C to pull flow towards the trailing edge. The difference in geometry between the airfoils 30 and the airfoils 40 illustrates that any appropriate shape of airfoil may be used, provided it induces a gas flow against a direction of the leakage path B, as described above.

During operation, the leakage path B is (are) therefore sealed or reversed in the compressor section 10, in the following manner: gas is received in one of the downstream cavities D during operation of the gas turbine engine, such that a pressure in a first cavity, the downstream cavity D, is greater than a pressure in a second cavity, the upstream cavity C, for a given stator portion. This creates the potential of a leakage path B through the annular gap B1 separating the downstream cavity D and upstream cavity C, from higher pressure to lower pressure. A flow of gas is induced from the upstream cavity C, through the annular gap B1, to the downstream cavity D, by rotation of the rotor hub 15 with the dynamic seal 20 thereon. The rotation of the rotor hub 15 occurs inherently during operation of the gas turbine engine, and this inherent operation is not modified or altered to cause the pumping action of the dynamic seal 20.

The above description is meant to be exemplary only, and one skilled in the art will recognize that changes may be made to the embodiments described without departing from the scope of the invention disclosed. For example, the stator may not have the annular platform 16 to define the annular gap, as the annular gap may be defined by the inner shroud, etc. Still other modifications which fall within the scope of the present invention will be apparent to those skilled in the art, in light of a review of this disclosure, and such modifications are intended to fall within the appended claims, for instance using an impeller like design. Moreover, although the sealing system is described as being used in a compressor section, it could also be used for under-stator sealing in a turbine section of a gas turbine engine.

What is claimed is:

1. A seal arrangement for a gas turbine engine comprising:
a rotor hub;
a stator portion projecting toward the rotor hub, an annular gap formed between the rotor hub and an end of the stator portion, a leakage path being defined from a first cavity on a first side of the stator portion, through the annular gap, and to a second cavity on a second side of the stator portion by positive pressure differential from the first cavity to the second cavity when in operation; and
a dynamic seal secured to the rotor hub, the dynamic seal having geometrical features positioned relative to the annular gap to induce a flow of gas through the annular gap from the second cavity to the first cavity when in operation and rotating with the rotor hub.

2. The seal arrangement according to claim 1, wherein the geometrical features of the dynamic seal are airfoils circumferentially distributed on and projecting from a surface of the rotor hub.

3. The seal arrangement according to claim 2, wherein the airfoils have a concave pressure surface and a convex suction surface.

4. The seal arrangement according to claim 2, wherein the airfoils have straight surfaces from leading edge to trailing edge, with a width of passages between adjacent pairs of the airfoils being greater at the trailing edge than at the leading edge.

5. The seal arrangement according to claim 2, wherein the airfoils are on a base ring secured to the rotor hub.

6. A gas turbine engine of the type having at least one of a turbine section and a compressor section defined by a rotor hub, a stator portion projecting toward the rotor hub, an annular gap formed between the rotor hub and an end of the stator portion, a leakage path being defined from a first cavity on a first side of the stator portion, through the annular gap, and to a second cavity on a second side of the stator portion by positive pressure differential from the first cavity to the second cavity when in operation, the gas turbine engine comprising:
a dynamic seal secured to the rotor hub, the dynamic seal having geometrical features positioned relative to the annular gap opposite the end of the stator portion.

7. The gas turbine engine according to claim 6, wherein the geometrical features of the dynamic seal are airfoils circumferentially distributed on and projecting from a surface of the rotor hub.

8. The gas turbine engine according to claim 7, wherein the airfoils have a concave pressure surface and a convex suction surface.

9. The gas turbine engine according to claim 7, wherein the airfoils have straight surfaces from leading edge to trailing edge, with a width of passages between adjacent pairs of the airfoils being greater at the trailing edge than at the leading edge.

10. The gas turbine engine according to claim 7, wherein the airfoils are on a base ring secured to the rotor hub.

11. A method for sealing a leakage path in a gas turbine engine, the leakage path being defined from a first cavity on a first side of a stator portion, through an annular gap, and to a second cavity on a second side of the stator portion, the method comprising:
receiving gas in the first cavity during operation of the gas turbine engine, such that a pressure in the first cavity is greater than a pressure in the second cavity; and
inducing a flow of gas with a dynamic seal from the second cavity, through the annular gap, to the first cavity, by rotation of the rotor hub.

12. The method according to claim 11, wherein inducing the flow of gas comprises rotating airfoils of the dynamic seal with the rotor hub.
